(19) United States
(12) Patent Application Publication
(10) Pub. No.: US 2018/0325630 A1
(43) Pub. Date: Nov. 15, 2018

(54) CICATRISATION ELEMENT FOR RESTORATIVE DENTISTRY

(71) Applicant: EUROTEKNIKA, Sallanches (FR)

(72) Inventors: Théo Leger, Domancy (FR); Benjamin Calvat, Ugine (FR); Cédric Lancieux, Cordon (FR)

(73) Assignee: EUROTEKNIKA, Sallanches (FR)

(21) Appl. No.: 15/770,962

(22) PCT Filed: Oct. 24, 2016
(86) PCT No.: PCT/EP2016/075507

§ 371 Date: Apr. 25, 2018

(30) Foreign Application Priority Data
Oct. 27, 2015 (FR) 1560235

(51) Int. Cl. A61C 8/00; A61C 9/00

(52) U.S. Cl. CPC A61C 8/008; A61C 8/0001; A61C 2204/005; A61C 8/0054; A61C 9/004

(57) ABSTRACT

Cicatrisation element capable of a connection to a dental implant (60), comprising a lateral surface (13) designed to be integrated inside a gum in order to structurize the gum during its cicatrisation, and a terminal surface (14), characterized in that one portion of the lateral surface (13) and of the terminal surface (14) forms an emergent surface which is asymmetrical with respect to at least a median perpendicular plane and in that the emergent surface comprises at least two informative markers (70) making it possible to identify at least two characteristics of said cicatrisation element and/or of a post base (1) and/or of said dental implant (60) to which it will be connected.

The present invention relates to a cicatrisation element for a dental restoration and to a healing set comprising such a cicatrisation element. It also relates to a method of fabricating a dental restoration post and/or a denture based on such a cicatrisation element.

Dental restoration makes it possible to produce an artificial denture in a patient having lost some or all of their teeth. It is based on the integration of one or more implants in the bone structure, performed by an incision of the gum in order to reach and penetrate the bone structure. After this, a cicatrisation element is generally secured to an implant and this set remains intact until such time as the implant is incorporated in the bone structure by osteointegration and cicatrisation of the gum around the cicatrisation element. The dental restoration may be completed by the fixation of a restoration post to the implant, on which the denture is secured, or in a variant the fixation of a denture directly to the implant. The post and the denture are personalized, adapted to the anatomy of the patient and to the tooth being replaced, in order to accomplish a result as close as possible to the ideal natural dentition. For this, the precise volume of the space being restored is generally taken into account, by taking an impression, which allows the personalized fabrication of the denture.

In the prior art, the existing methods of dental restoration are faced with some or all of the following technical problems:
in many existing methods, a new intervention on the gum is performed after its cicatrisation following the implant rest period, to take the impression, physical or digital, of the space being restored, taking into consideration the implant and the gum in order to allow precisely for this overall geometry, in order to fabricate a post and a denture of precise shape: this method is of course traumatizing;
other existing methods limit this traumatization by using cicatrisation components which are not removed when taking the impression, so as not to affect the gum: on the other hand, these methods make use of particular cicatrizing elements, generally of cylindrical standard shape and occasionally integrating supplemental components to allow a consideration of some or all of the geometry above the implant without having total access to it by the taking of an impression. These less traumatizing methods thus have other drawbacks, of complexity and/or less optimization of the cicatrisation phase.

Thus, a general objective of the invention is a dental restoration solution without some or all of the drawbacks of the prior art.

More precisely, a first objective of the invention is a dental restoration solution which minimizes the traumatization of the patient during the restoration process.

A second objective of the invention is a dental restoration solution which allows a restoration adapted as much as possible to the anatomy of the patient.

A third objective of the invention is a dental restoration solution which is as universal as possible, adapted to all implants and all restorations.

A fourth objective of the invention is a dental restoration solution which is as simple as possible.

For this purpose, the invention is based on a cicatrisation element capable of a connection with a dental implant, having a lateral surface designed to be integrated inside a gum in order to structurize the gum during its cicatrisation, and a terminal surface, characterized in that one portion of the lateral surface and of the terminal surface form an emergent surface which is asymmetrical with respect to at least a median perpendicular plane and in that the emergent surface comprises at least two informative markers making it possible to identify at least two characteristics of said cicatrisation element and/or of a post base and/or of said dental implant to which it will be connected.

The emergent surface of the cicatrisation element can be asymmetrical with respect to at least a median plane perpendicular to the emergent surface and passing through the center of the emergent surface or comprising a central axis of the cicatrisation element.

A section transverse to the lateral surface of the cicatrisation element or a projection onto a plane parallel to the terminal surface of the emergent surface of the cicatrisation element may have:
a substantially trapezoidal shape or a substantially polygonal, or triangular, or square, or rectangular, or ovoid shape, or a substantially polygonal shape with rounded corners; and/or
a portion designed for a positioning oriented toward the outside of the mouth with larger dimension than a portion designed for a positioning oriented toward the inside.

The terminal surface of the cicatrisation element and/or its emergent surface may have:
a nonplanar, curved surface; and/or
a convex surface; and/or
a surface with no roughness apart from the informative markers; and/or
a surface with no through opening.

Said characteristics identified by the informative markers can comprise one or more of the following:
the height of the cicatrisation element,
the shape of the cicatrisation element, in particular the shape and the dimensions of the cross section of its lateral surface or the projection onto a parallel plane of the emergent surface,
the dimensions of the connecting portion of the cicatrisation element to a post base, and indirectly of a dental implant,
the orientation of said dental implant, through the orientation of the cicatrisation element.

Said at least two informative markers can comprise a first type of informative marking of a first characteristic of the cicatrisation element and a second type of informative marking of a second distinct characteristic of the cicatrisation element.

Each informative marker can belong to one of the following types:
a negative informative marker, in particular recessed in one of the surfaces of the cicatrisation element,
a positive informative marker, in particular embossed on one of the surfaces of the cicatrisation element,
an informative marker of specific and identifiable shape formed in one of the surfaces of the cicatrisation element, in particular a polygonal shape or line,
an informative marker composed of a readable numerical value or a readable identification code such as a bar code or a data matrix code,
an RFID chip.

The invention also relates to a series of cicatrisation elements, characterized in that it comprises at least two cicatrisation elements as previously described, having different shapes, or in that it comprises at least three cicatrisation elements of different shapes.

Said at least two or at least three cicatrisation elements can have different heights from each other and/or can have different cross sections of their lateral surfaces or different projections onto a parallel plane of their terminal surfaces.

The invention also relates to a healing set capable of a connection to a dental implant during a cicatrisation phase of a dental restoration process, characterized in that it comprises a cicatrisation element as previously described designed to be surrounded at least partially by a gum and a post base designed to be fixed in an implant, the post base having a longitudinal axis for its entire length, able to be aligned with the axis of said implant.

The post base can be symmetrical or quasi-symmetrical about its longitudinal axis.

The cicatrisation element and the post base can form two separate elements which are assembled detachably, in particular by clipping, and
the post base can comprise a connection device to an implant and a connection device to the cicatrisation element, these two connection devices being arranged about an axis aligned and coincident with the longitudinal axis of the post base, and
the cicatrisation element can be arranged around a central axis aligned with the longitudinal axis of the post base.

The cicatrisation element can comprise an anti-rotation element, especially a groove, to cooperate with an anti-rotation element, especially a tab, of the post base, and to guarantee a fixation of the cicatrisation element in a unique orientation, without rotation about the post base.

Said at least two informative markers of the cicatrisation element can comprise a first informative marking of a first characteristic of the post base and a second informative marking of a second characteristic of the post base.

The invention also relates to a method of fabrication of a dental restoration post and/or of a denture, designed to be secured to a dental implant at a first end, characterized in that it involves the following steps:
production of a physical or digital impression of the buccal space, comprising a cicatrisation element as previously described which is secured to the dental implant or a healing set as previously described which is secured to the dental implant;
automatic determination and/or determination on the basis of data entered through a man/machine interface by an operator, of the positioning of the dental implant and of the buccal space, on the basis of said impression and the informative markers of the cicatrisation element.

These objectives, characteristics and advantages of the present invention will be explained in detail in the following description of a particular embodiment given in nonlimiting manner in regard to the enclosed figures, of which:

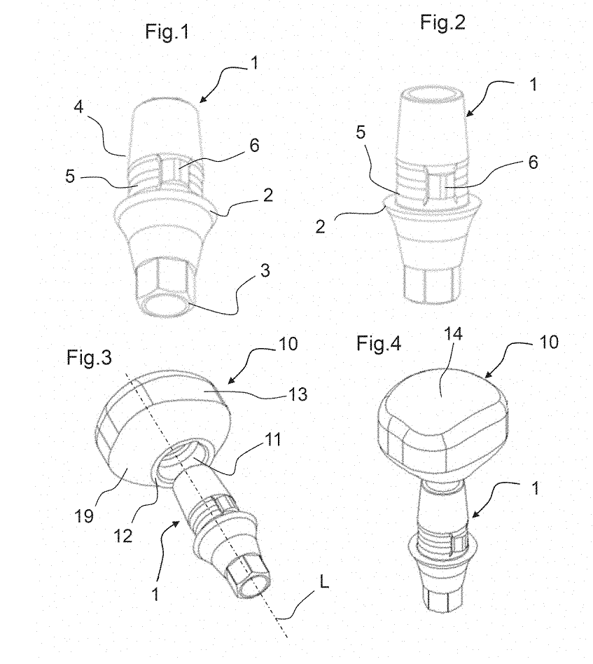

FIGS. 1 and 2 show respectively perspective views of a post base used in a restoration method according to one embodiment of the invention.

FIGS. 3 and 4 show respectively perspective views of an intermediate phase of association of a cap on a post base in a restoration method according to the embodiment of the invention.

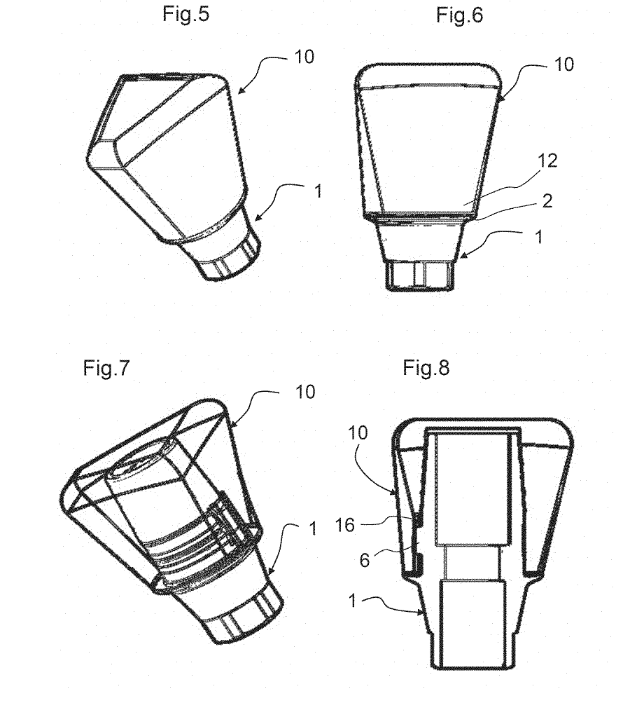

FIGS. 5 and 6 show respectively perspective views of the set obtained after fixation of a cap to a post base in a restoration method according to the embodiment of the invention.

FIGS. 7 and 8 show respectively the same perspective views in which the cap is shown as being transparent in order to reveal the post base.

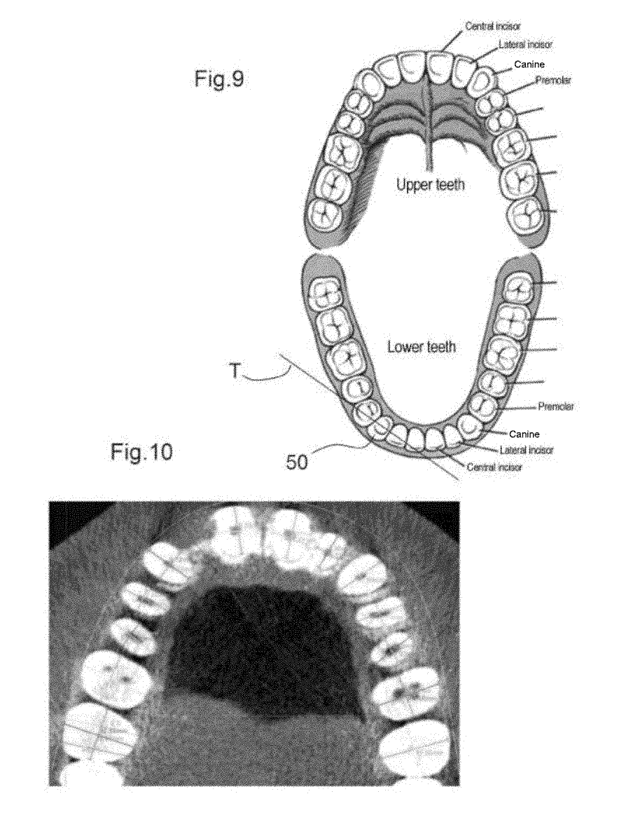

FIG. 9 shows the lower and upper teeth in a top view.

FIG. 10 shows a view of the teeth in a justa-gingival section.

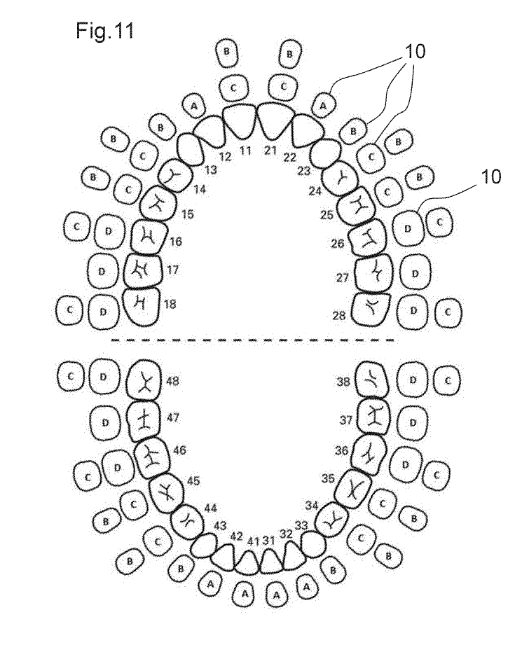

FIG. 11 shows a horizontal section of the dentition at the justa-gingival level, as well as the corresponding caps observed according to the embodiment of the invention.

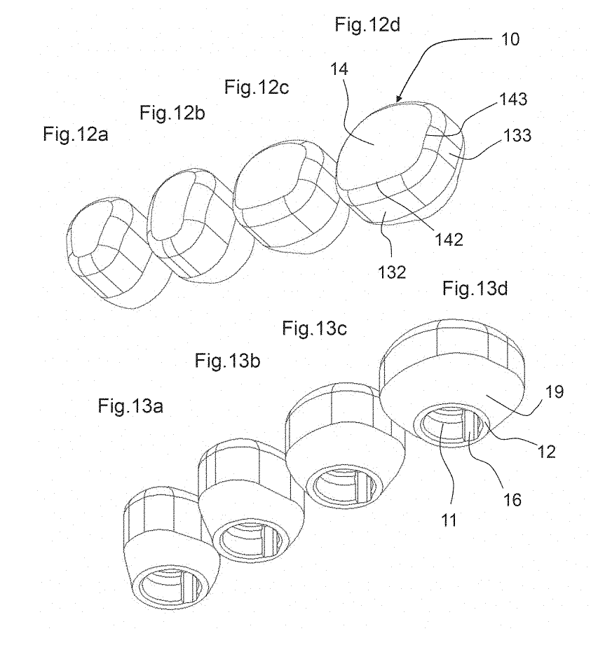

FIGS. 12a to 12d and 13a to 13d show respectively perspective top and bottom views of a series of caps according to the embodiment of the invention.

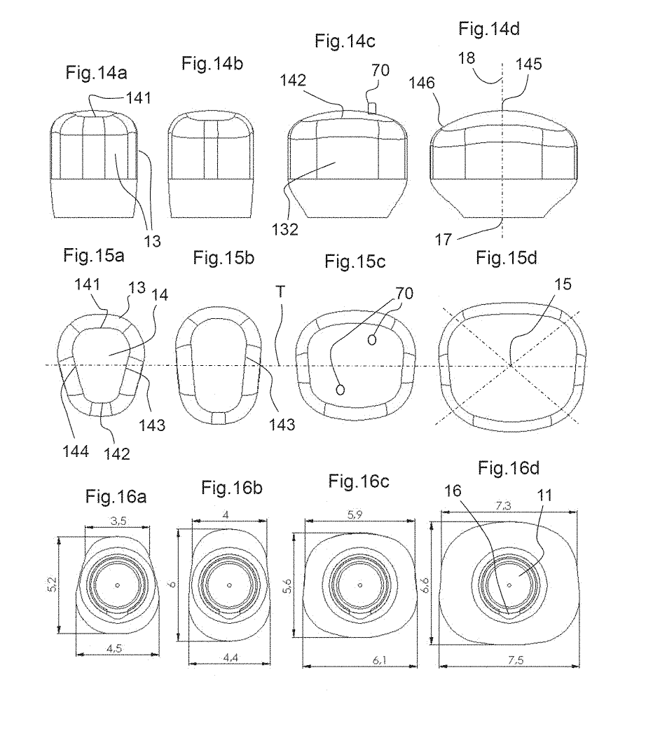

FIGS. 14a to 14d show respectively side views of the series of caps according to the embodiment of the invention.

FIGS. 15a to 15d show respectively top views of the series of caps according to the embodiment of the invention.

FIGS. 16a to 16d show respectively bottom views of the series of caps according to the embodiment of the invention.

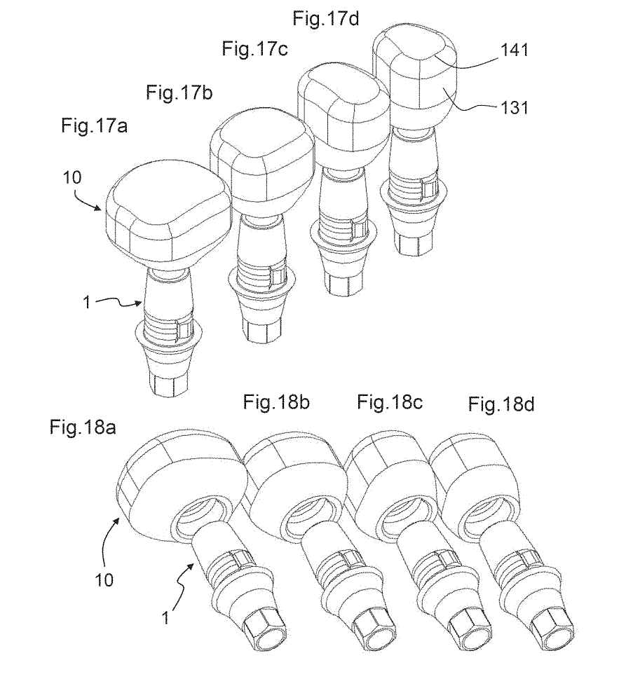

FIGS. 17a to 17d and 18a to 18d show respectively perspective top and bottom views of an intermediate phase of association of the series of caps with post bases in a restoration method according to the embodiment of the invention.

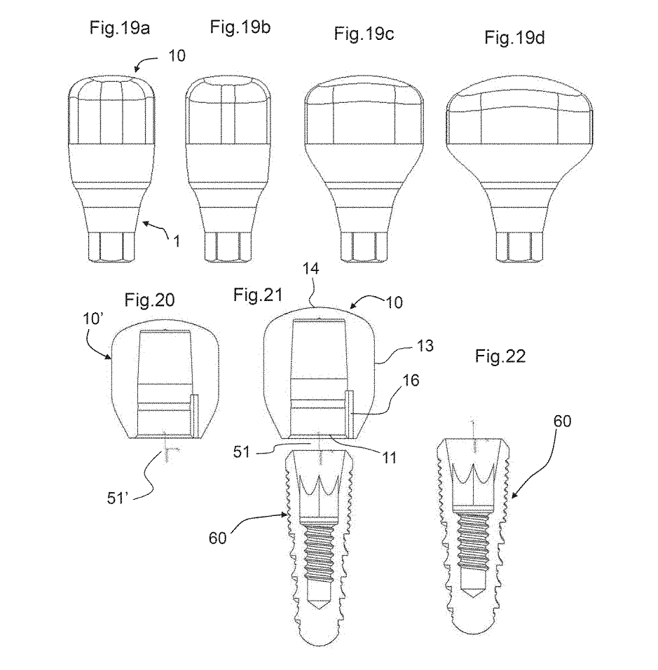

FIGS. 19a to 19d show respectively side views of the series of caps assembled with the post bases according to the embodiment of the invention.

FIGS. 20 to 22 show sectional views through a vertical median plane illustrating the steps of the restoration method according to one embodiment of the invention.

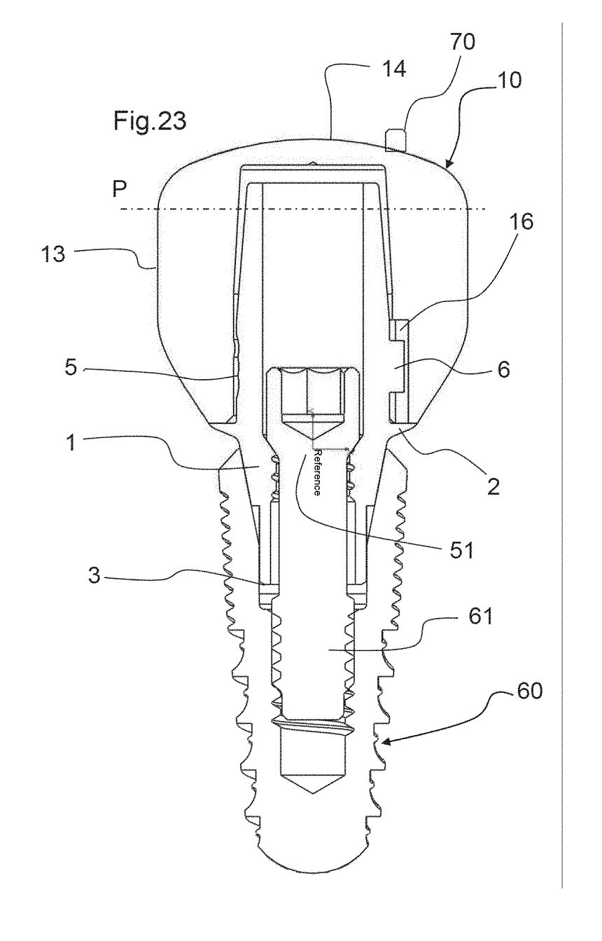

FIG. 23 illustrates a sectional view of a cap according to the embodiment of the invention arranged on a post base fixed in an implant.

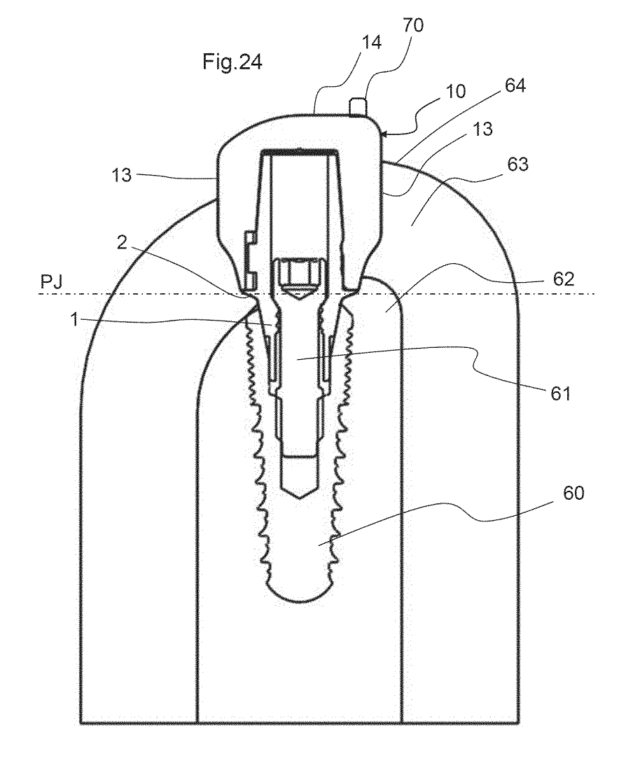

FIG. 24 illustrates a sectional view of a healing set comprising a cap surrounded by the gum and arranged on a post base fixed in an implant according to the embodiment of the invention.

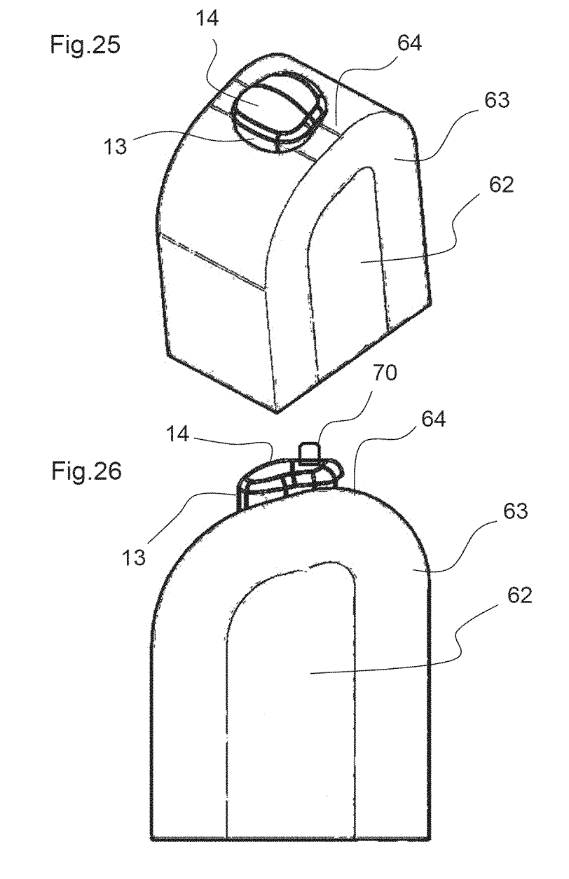

FIGS. 25 and 26 show two schematic views of a gum in cross section, within which is secured a healing set according to the embodiment of the invention.

The restoration method according to the embodiment of the invention thus involves two phases, as explained above: a first so-called cicatrisation phase during which one or more implant(s) are integrated in the bone structure of the patient by osteointegration, and during which a particular cicatrisation cap associated with a post base are used, as shall be explained below, then a second restoration phase proper, during which a definitive denture is put in place on the one or more implants by means of a restoration post.

According to the embodiment of the invention which is going to be described, a dental restoration in the first phase of cicatrisation makes use of an intermediary component which we shall call the post base 1, sometimes simply called a post or T-base or Esthetibase. The post base 1, shown in particular in FIGS. 1 to 8, comprises two main parts, separated by a collar 2. A first part comprises a connection device 3 to an implant. A second crown part is designed to receive a cicatrisation cap 10. For this, it comprises a connection device 4 to said cap. According to the embodiment, this connection device 4 comprises a clipping element 5 and an anti-rotation element 6, to prevent the cap from turning about the longitudinal axis L of the post base 1, this longitudinal axis L being furthermore designed to be aligned with the axis of an implant. According to the embodiment, the anti-rotation element 6 is a tab. This anti-rotation element 6 is moreover aligned with a particular surface of the connection device 3 to an implant. Moreover, according to the embodiment, the clipping element 5 is formed by several grooves arranged on the circumference of the post base 1 in the vicinity of the collar 2. Advantageously, the clipping element 5 is such as to allow an audible click when secured by clipping of a cicatrisation cap 10.

It should be noted that the post base 1 used is not definitive, it participates only in the first phase of cicatrisation, and is preferably removed during the completion of the restoration and replaced by a definitive restoration post (which may be in the form of another base). As a variant, the same post base 1 may optionally be removed, cleaned, and reused in the definitive restoration, then performing the second function of a restoration post.

Moreover, the post base 1 is preferably universal, and it has a symmetrical or, more precisely, quasi-symmetrical shape (the anti-rotation element for example is an exception to the symmetry) about a longitudinal axis L which forms an axis of revolution. Thus, this axis L forms in particular a central axis of symmetry of the connection device 3 to an implant. Advantageously, this same axis L also forms an axis of symmetry of the connection device 4 to a cap. The post base 1 thus extends overall in a single direction, identified by a single longitudinal axis L. We may thus more generally consider that the post base has a longitudinal axis L which extends for its entire length, so as to be aligned with the axis of an implant 60. In particular, the two connection devices 3, 4 of the post base 1 are arranged at different levels around this same longitudinal axis L.

After the fixation of an implant 60 during a dental restoration method, a post base 1 is secured to the implant 60 by its connection device 3, and by means of a screw 61, and then a cap 10 is secured to the second crown portion of the post base. This assembly is illustrated by FIGS. 23 and 24. As illustrated especially by FIGS. 3 and 7, the cap 10 has an opening 11 to form a connection portion and a hollow interior volume, designed for the insertion of the second crown portion of the post base. The contour of this opening 11 has a surface 12 designed to bear against a corresponding planar surface of the collar 2 of the post base, after clipping of the cap 10 to the post base, in order to obtain the assembled set shown by FIGS. 5 to 8 and 19a to 19d.

There are as many different post bases as there are different connection devices for existing implants, in order to have for each existing implant a post base having a connection device 3 adapted to it. The advantage of this approach is that it allows one to keep the entire second crown portion of the post bases, starting with the collar 2, unchanged, regardless of the implant corresponding to the post base. Of course, it is also possible to provide different second crown portions for different post bases, depending on their contemplated use. In any case, the second crown portion of the post base is independent of the implant, and not correlated with the fixation device of the implant.

The function of the cap 10 is to be lodged inside the incised gum, after fixation of an implant, by preferably removable fixation to a post base connected to the implant. The final configuration is shown in FIG. 24. In this configuration, the implant 60 is joined to the bony portion 62, the post base 1 is secured to the implant 60, such that its collar 2 is positioned in the area of the border between the bony portion 62 and the gum 63. The cap 10 covers the post base 1 as far as the collar 2, so that the gum 63 is almost exclusively in contact with the cap 10. The set formed by the assembly of a cap on a post base thus corresponds to a healing set, which is temporarily involved in the restoration process, allowing the cicatrisation and nontraumatic fabrication of the definitive denture, as will be explained below.

The gum 63 thus heals around the lateral surface 13 of the cap 10. For this, this lateral surface 13 is chosen to best correspond to the buccal environment of the patient. The terminal surface 14 opposite the opening 11 of the cap is designed to remain visible above the gingival surface 64 of the gum 63, or at least partially visible, since the gum remains primarily in contact with the lateral surface 13 of the cap. It should be noted that at least a portion of the terminal surface 14 and optionally a top portion of the lateral surface 13 thus form an emergent surface of the cap. This emergent surface is illustrated in particular by FIGS. 25 and 26. For this, caps of different height can be provided to adapt to different configurations of the buccal geometry. By way of example, three different standard heights allow a good adaptation to every situation. This height is advantageously between 3 and 7 mm. Due to the use of a post base which plays the role of an interface, a same cap 10 is thus universally adapted to all the existing implants.

According to the embodiment of the invention, the shape of the cap is chosen specifically to encourage the cicatrisation of the gum in an anatomical form best corresponding to the tooth being replaced and consequently as well for the future denture which will occupy this buccal space. This shape is characterized in particular by the plane cross section of its lateral surface 13, this section being a section passing through a plane P perpendicular to the lateral surface 13, shown in FIG. 23, and substantially parallel to the terminal surface 14. It will be noted that this section is substantially reproduced by the shape of the terminal surface 14, or more precisely by the projection of this terminal surface 14 onto such a perpendicular plane, that is, substantially parallel to the gingival surface 64.

In order to understand the method adopted, FIG. 9 shows a top view of the upper and lower teeth and FIG. 10 shows a sectional view in the area of the justogingival plane PJ of a dentition, represented in FIG. 24, at the level of the base of the tooth emergences. These figures show that the teeth have cross sections of different shapes, which can be simplified as rectangular and/or square and/or triangular shapes, but more precisely trapezoidal shapes.

According to the embodiment chosen, a series of caps 10 of different shapes will best enable a reproduction of these different shapes. FIG. 11 thus shows a top view of cross sections of all the teeth and a top view of caps 10 associated with each tooth. The shapes of the different series of teeth, numbered from 11 to 18, from 21 to 28, from 31 to 38 and from 41 to 48 in this figure, while these numbers should not be confused with the numerical references used elsewhere in the other figures to designate the characteristics of the invention, are all approximated by the use of four different caps 10, referenced as A to D. For certain teeth, or even all the teeth, several of the caps, among the caps A to D, will appear to be suitable.

As will be set out in detail below, a cicatrisation element forming the subject matter of the invention will be equally able to correspond either to the assembly formed by a post base and by one of the caps of the series fixed to the post base opposite its connection to the dental implant, or to a unitary cicatrisation element directly fixed to the dental implant 60 without use of the post base.

Thus, more generally, a series of cicatrisation elements will be such that the cicatrisation elements of which it is composed have different heights from each other and/or have different cross sections of their lateral surfaces 13 or different projections onto a parallel plane of their emergent or terminal surfaces.

Within a same series of cicatrisation elements, the cross sections of the lateral surfaces 13 or the projections onto a parallel plane of their emergent or terminal surfaces 14 are each of: a substantially trapezoidal shape or a substantially polygonal shape, or triangular, or square, or rectangular, or ovoid, or a substantially polygonal shape with rounded corners, or cylindrical.

In the embodiment chosen and illustrated in FIG. 11, the caps A are adapted to handle the restoration of the upper lateral incisors and all the lower incisors. The caps B are adapted to the restoration of the canines and the premolars, the caps C are adapted for the restoration of the intermediate molars, and the caps D are adapted for the restoration of the largest molars. These caps shall now be described in further detail. Cap A is particularly illustrated by FIGS. 12a to 16a, cap B by FIGS. 12b to 16b, cap C by FIGS. 12c to 16c and cap D by FIGS. 12d to 16d. So as not to clutter up the figures, the numerical references are not reproduced on all the caps of these figures; however, all these caps have the same characteristics, which shall be described.

As emerges from FIGS. 12 and 15, the terminal surfaces 14 of these caps 10 (A to D), designed for a positioning above the gingival emergence, are substantially planar and designed for a positioning parallel to a horizontal plane (parallel to the justa-gingival plane PJ, between 1 and 2 mm included above this plane) corresponding to the sectional plane of FIG. 9. However, they are slightly convex, having a central part 145, more particularly visible in FIGS. 14a to 14d, designed to rise more above the gum than its peripheral portions 146.

The transverse section of the cap, through a plane P perpendicular to its lateral surface 13, as explained above, giving the final shape to the gum after the cicatrisation, is substantially reproduced by the terminal surface 14 of the cap, which is a prolongation thereof. The sections of all the caps all have a substantially trapezoidal shape. They comprise a large side 141, which will be situated on the external side of the mouth (vestibular side), an opposite and parallel small side 142, which will be situated on the inside of the mouth (lingual side), joined by two sides 143, 144. The intersection of the diagonals of the trapezium makes it possible to define a center 15. Moreover, considering the center 17 of the substantially circular opening 11 of the opposite surface of the cap 10, it is possible to define a central axis 18 of the cap, passing through the two central points 15, 17. This axis 18 of the cap 10 is perpendicular to the terminal surface 14. The entire architecture of the post base and associated cap 10 is designed so that the axis 18 of the cap corresponds to the longitudinal axis L of the post base, and to the axis of the implant.

The four types of caps 10, A, B, C and D thus differ in particular in the trapezoidal shape of the cross section of their lateral surfaces 13. The trapezium of the smallest cap A approximates a triangle, since its small side 142 is very reduced. The trapezium of the cap B approximates a rectangle whose large side runs from the outside to the inside of the mouth, and corresponds to the sides 143, 144. On the contrary, the trapeziums of the caps C and D approach a rectangle, or even a square, whose large side is in the opposite direction, and corresponds to the sides 141, 142, which have similar but slightly different length. As sample embodiments, FIGS. 16a to 16d show the orders of magnitude of the dimensions of these caps, in millimetres.

Of course, this substantially trapezoidal shape adopted has rounded corners and curved sides, in order to guarantee no trauma to the gum. Moreover, the terminal surface 14 of each cap, disregarding the markers which are arranged on this surface and will be described further below, presents a continuous surface, with no relief, and/or with no hollow portion, and/or with no groove, and/or with no ridge, and/or with no roughness. This surface is convex. In particular, it does not have a hollow shape, and of the course no through opening, such as would be necessary if it were chosen to attach the cap by a fixation screw. This geometry with no roughness is favourable to oral hygiene, for example, it prevents the accumulation of food and the deposition of dental plaque.

As a variant, the series of caps could include a different number of different geometries, for example at least three, or at least two. In one simplified variant, a single shape of cap could suit all the teeth.

According to other variant embodiments, the transverse section of a cap in the area of its lateral surface 13 could approximate any polygon, such as a polygon of three, five, or six sides. As a variant, the angles of these polygons could be so rounded that the overall shape would approximate an oblong shape, or even an ovoid cross section, or any other elongated shape of a polygon. Advantageously, this shape comprises at least one center or perfectly defined geometrical point to define a center 15, or even an axis 18 of the cap, this center being advantageously, but not necessarily, in the alignment of the longitudinal axis L of the post base.

According to the embodiment, the geometry of the visible emergent surface of the cap on the inside of the mouth differs from the geometry on the outside, in order to take account of the curvature of the gum. This shape of the emergent surface of the cap is thus asymmetrical with respect to a median plane containing the tangent T of the gum, and passing through the center of the cap, known as median tangent plane; this tangent T (and thus the projection of the median tangent plane) is represented in FIGS. 15a to 15d and more precisely in FIG. 9, considering one tooth 50 being restored. This median plane, or tangent plane T, is parallel to the tangent T to the gum, perpendicular to the justogingival plane PJ, and passes down the middle 15 of a cap.

Thus, a shape of circular section for the cross section of the cap, associated with a cylindrical cap for example, is ill-suited. More generally, any plane section having a symmetry about a point or an axis is ill suited or not at all suited for the aforementioned cross section of the cap, since it would not be adapted to the anatomy of the mouth. For the same reasons, the emergent and visible surface of the cap, in particular the terminal surface 14, is thus more generally not symmetrical with respect to at least one, or even several planes including its axis 18. It is not symmetrical with respect to at least one or several planes perpendicular to the terminal surface 14 and passing through its center 15. We will call median perpendicular plane a plane corresponding to a definition given above. Such a plane is substantially perpendicular to the terminal surface 14 of the cicatrisation element, and therefore also substantially perpendicular to the justogingival plane forming the final surface of the gum, from which the teeth emerge. It passes through the center of the terminal surface 14. Alternatively, a median perpendicular plane may be defined as any plane containing the axis 18 of the cap. In the example represented, particularly visible in FIGS. 15a to 15d, only the median plane perpendicular to the mentioned tangent plane T, passing down the middle of the two sides 141, 142, forms a plane of symmetry.

The terminal surfaces 14 of the caps are prolonged, starting from their periphery 146, by the lateral surface 13 about which the gum is primarily cicatrising, and which thus shapes the gum suitably for the future denture. This lateral surface 13 has several surfaces 131, 132, 133, 134, substantially planar, possibly slightly curved, extending in a direction substantially parallel to the axis 18 of the cap and/or parallel to the longitudinal axis L of the post base, respectively prolonging the different sides 141, 142, 143, 144 of the terminal surface 14 of the cap. The interfaces between the terminal surface 14 and these different portions of the lateral surface 13 are realized by rounded surfaces, with no roughness, in particular convex ones.

Finally, the lateral surface 13 of the caps is terminated by a substantially truncated conical surface 19 as far as the substantially circular opening 11, previously mentioned. This opening 11 emerges onto a hollow portion inside the cap 10, allowing for the lodging of the second crown portion of the post base. This hollow portion is provided with a fixation device in addition to that 4 of the post base. In the embodiment, this involves bulges provided to clip onto the grooves 5 of the post base. Finally, a substantially longitudinal groove 16 is arranged in this hollow portion of the cap in order to cooperate with the tab, thus forming a connection which is locked in rotation, and perfectly indexed, the orientation of the cap being unique and perfectly established. FIGS. 3 to 8 and 17a to 17d, 18a to 18d and 19a to 19d show in particular a healing set according to the invention, formed by the assembly of a cap 10 with a post base 1.

The cap can be formed of plastic material compatible with medical use, and be pink, white or cream in color. As a variant, it can be made of metal, such as titanium, or can be made of zirconium. The use of the cicatrisation caps thus allows an encouraging of an ideal cicatrisation of the gum in a dental restoration process, as has been discussed, on account of its geometry conceived in harmony with the buccal anatomy. The solution has been described with a removable cicatristion cap, distinct from a base, in the preceding embodiment. It should be noted that this cicatrisation element as a variant may be totally subgingival and invisible, and then be made visible by a procedure on the gum to carry out the rest of the reconnaissance process which is described below. In this case, the end portion of the cap will always be called inappropriately the emergent portion. The cap 10 will also be called more generally a “cicatrisation element” 10 in the following.

For each cicatrisation cap 10 as described above, the emergent surface, formed by the terminal surface 14 and possibly the upper part of the lateral surface 13, advantageously comprises at least two informative markers for identifying at least two characteristics of the cicatrisation cap 10 and/or indirectly of the post base 1 and/or of the dental implant 60. The provision of such informative markers on the cicatrisation cap 10 makes it possible to dispense with a traditional technique of taking an impression on the implant and makes it possible to reduce the time required and the complexity, in order then to develop the dental restoration post which will replace the cicatrisation cap 10 and the post base 1, and on which the final denture will be arranged.

According to one embodiment, the characteristics identified by the informative markers comprise one or more of the following:
the height of the cicatrisation cap 10,
the shape of the cicatrisation cap 10, in particular the shape and the dimensions of the cross section of its lateral surface 13 or of the projection onto a parallel plane of the emergent surface,
the dimensions of the connecting portion of the cicatrisation cap 10 to the post base, and thus indirectly of the dental implant 60,
the orientation of the dental implant 60, through the orientation of the cap, for example by a marker aligned with an anti-rotation element of the cap, for example the groove 16.

According to a particular embodiment, said at least two informative markers comprise a first type of informative marking of a first characteristic of the cicatrisation cap 10 and a second type of informative marking of a second characteristic of the cicatrisation cap 10. These first and second characteristics associated with the cicatrisation cap 10 are in particular the height of the cicatrisation element 10 and/or the shape of the cicatrisation cap 10, in particular the shape and the dimensions of the cross section of its lateral surface 13 or of the projection onto a parallel plane of the emergent surface. Indirectly, a marker can allow information to be deduced concerning the post base and optionally the implant, such as their orientation, which may be associated with the orientation of the cap.

Without limitation on the freedom of design of the informative markers, each informative marker belongs in particular to one of the following types:
a negative informative marker, in particular recessed in one of the surfaces of the cicatrisation cap 10, particularly on its emergent surface,
a positive informative marker, in particular embossed on one of the surfaces of the cicatrisation cap 10, particularly on its emergent surface,
an informative marker of specific and identifiable shape formed in one of the surfaces of the cicatrisation cap 10, in particular a polygonal shape or line,
an informative marker composed of a readable numerical value or a readable identification code such as a bar code and/or a data matrix code. This marker can be composed of numbers and/or letters and/or any symbol and/or colors and/or laser markings;
an informative means composed of an RFID chip.

It should be noted that the geometric considerations described previously for characterizing the cicatrisation element are true disregarding the informative markers. For this reason, these markers 70 are not illustrated in the figures, with the exception of FIGS. 14c, 15c, 23, 24 and 26, so as not to clutter up the figures. However, they are of course present on all of the caps.

For example, the characterization of the negative informative marker, which is for example a simple hole, is for example its position relative to the rest of the cap 10 in which it is formed, its size, its shape, or the number of such negative informative markers. These characteristics of each negative informative marker precisely make it possible to characterize the characteristic of the cicatrisation cap 10 and/or of the post base 1 characterized by the negative informative marker(s), such as the height of the cicatrisation element. It is then possible for example to deduce from this the vertical position of the post base 1.

Still by way of example, these same characteristics can be deduced from the characterization of the positive informative marker, which is for example its position relative to the rest of the cap 10 in which it is formed, its size, its shape, or the number of such positive informative markers. These characteristics of each positive informative marker precisely make it possible to characterize the characteristic of the cicatrisation cap 10 and/or of the post base 1 and therefore of the dental implant 60 characterized by the positive informative marker(s).

Another example of such informative markers of specific and identifiable shapes is a notch formed directly in the cicatrisation cap 10 itself. The joint presence of two such notches and the distance separating them can serve to indicate, for example, the position and the type of post base and, consequently, the dental implant 60. A third example of such informative markers of specific and identifiable shapes is a line, such as an engraving or a relief, integral with the cicatrisation cap 10. The size and the position of this line and/or the number of such lines can serve to characterize a supplementary characteristic of the cicatrisation cap 10 and/or of the post base 1 and therefore of the dental implant 60.

Generally, the manufacture of a dental restoration post, intended to be fixed to the dental implant 60 at a first end and to receive a denture at its second end, comprises the following steps:
taking a physical or digital impression of the buccal space comprising a cicatrisation element as previously described which is fixed on the dental implant 60, for example one of the caps 10 of the series,
automatically determining, from this impression and from the informative markers of the cicatrisation element, the buccal space of the post base 1 and thus the positioning of the dental implant 60.

Besides the advantages previously described, the cicatrisation element makes it possible to carry out an advantageous restoration process, involving a method of fabrication of a definitive denture and post, with minimal traumatization of the gum. In fact, it is possible to obtain a digital or physical impression of the zone being restored without removing the cicatrisation element from the mouth, and thus without injuring the gum. Thus, besides its first function of cicatrisation, described above, the cap performs a second function during the restoration process by allowing the advantageous definition of the shape of the restoration post and/or of the denture prior to its removal. This function is supplemental to its first function of cicatrisation since it allows no traumatizing of the gum after its cicatrisation in an advantageous chosen anatomical form.

For this, at the end of the cicatrisation phase of the dental restoration process, a practitioner can take a digital impression of the mouth of the patient, without removing the cicatrisation element (the cap). The digitization data, obtained by any instrument such as a buccal scanner, for example, are transmitted automatically to a computer having dental restoration software.

This software comes with a man/machine interface by which an operator can indicate the cap model that it has used, or more generally the reference of the cicatrisation element, and optionally that of the implant and/or the post base used. The informative markers can be indicated to the software by the operator himself or identified automatically by the software by any suitable means of detection, recognition and identification, depending on the nature of the marker and of its characterization.

Using the digitization data and the informative markers, a software determines automatically the axis of the cicatrisation element, by geometrical construction, for example, based on the identification of the center 15 of the cap and the direction perpendicular to the terminal surface 14 passing through this center 15, then its orientation and the space which it occupies, by using the markers. It can thus in particular determine automatically the axis of the implant, without having to visualize it directly. In fact, the cicatrisation element is advantageously aligned with the implant, its axis being thus merged with that of the implant.

In fact, it is possible to deduce from the informative markers the orientation of the axis of the connection device to the implant, for example, the connection device 3 of the post base to the implant: this makes it possible to deduce automatically therefrom the positioning of the connection device to the implant, without having to visualize it directly, based on knowledge of the post base.

Finally, in the event that there are cicatrisation elements of different height, it remains to determine this height, in order to position the invisible implant perfectly. A first approach might involve producing cicatrisation elements of different color for different heights.

A second approach consists in providing and identifying at least one informative marker on the cicatrisation element to indicate this height.

In a variant or supplemental embodiment, an operator enters by a man/machine interface the reference of the cicatrisation element, which allows the software to retrieve certain characteristics of this cicatrisation element, as a confirmation of or in addition to those obtained by the markers, such as its height, its center and/or axis, from a library present in the form of a database stored in an electronic memory which can be consulted. FIG. 20 illustrates as an example a virtual cap 10′ memorized in the library associated with the restoration software. A reference in the space 51′ is associated with the cap, allowing its positioning in space. As a variant, the software can automatically recognize the cicatrisation element from its informative markers, or even its other geometrical characteristics, without manually entering its reference. An operator may assist a software in the proper positioning of the reference 51 of the actual cap, that is, in the recognition of its actual positioning, by entering one or more points of the emergent surface on an image obtained by the aforementioned digitization step and presented to the operator on a screen of a man/machine interface.

Based on digitized data, and possibly with the help of one or more points of the surface of the cicatrisation element manually indicated by an operator, the software then is able to associate the virtual cicatrisation element obtained from its library with the digitized buccal environment, replacing the real cicatrisation element, in order to obtain a more perfect digital reproduction. As shown in FIG. 21, the real reference 51 of the real cap 10 is thus determined automatically by the software. It is possible to perfectly position the virtual cicatrisation element on the digital impression, automatically or optionally with the aid of an intervention by an operator on a man/machine interface making it possible to visualize the buccal impression and the cicatrisation element. This perfect positioning of the virtual cicatrisation element makes it possible to deduce therefrom all the surrounding geometries, based on known references stored in the database associated with the precise cicatrisation element in question, including the position of the implant 60 and the geometry of the cicatrized gum without the presence of the cap 10, or that of the post base, as represented in FIG. 22. As a variant, the markers used serve to supply the data necessary for the correct positioning of the cap without recourse to a library.

In any case, when the restoration software has exactly repositioned the positioning of the hidden implant, it deduces from this knowledge the final geometry of the restoration post to be fabricated, which must be attached to the implant and occupy the entire gingival volume as defined by the cicatrisation element, and then the geometry of the denture which will be secured to this post, in known manner.

It should be noted that this restoration process can be done entirely digitally, therefore virtually, in a totally or partially automated manner, or it may involve phases of construction of a model in plastic or plaster. In the latter case, a physical impression, such as one made of silicone, can be taken, a plaster can be cast in the impression to create the master model, that is, a replica of the tooth arch being restored, which is then scanned in the laboratory to reconstruct a digital image.

As emerges from the above description, the last phase of the restoration process thus involves a restoration device, which comprises a central processing and control unit, here involving at least a microprocessor, connected to an electronic memory, on which a software is executed allowing the implementation of some or all of the steps of the restoration process described above. This central unit is linked by a communication device to a module for obtaining digital data representing some or all of a patient's dentition, which may consist of a device such as a buccal scanner.

It is likewise linked to a man/machine interface, comprising for example a screen and/or a keyboard, to enable exchanges with an operator, as explained above. The central unit then performs all necessary processing, calculations, and other operations, by a surface means. Finally, it is able to generate and transmit fabrication commands to a device for fabrication of a restoration post and/or a denture. It may furthermore be linked by a second communication device to a fabrication device such as a machine tool.

1. A cicatrisation element capable of a connection to a dental implant, the cicatrisation element comprising:
a lateral surface designed to be integrated inside a gum in order to structurize the gum during its cicatrisation, and
a terminal surface,
wherein one portion of the lateral surface and of the terminal surface forms an emergent surface, which is asymmetrical with respect to at least a median perpendicular plane and the emergent surface comprises at least two informative markers making it possible to identify at least two characteristics of the cicatrisation element and/or of a post base and/or of the dental implant to which the cicatrisation element will be connected.

2. The cicatrisation element as claimed in claim 1, wherein the emergent surface of the cicatrisation element is asymmetrical with respect to at least a median plane perpendicular to the emergent surface and passing through a center of the emergent surface or having a central axis of the cicatrisation element.

3. The cicatrisation element as claimed in claim 1, wherein a cross section to the lateral surface of the cicatrisation element or a projection onto a plane parallel to the terminal surface of the emergent surface of the cicatrisation element has:
a substantially trapezoidal shape or a substantially polygonal, triangular, square, rectangular, or ovoid shape, or a substantially polygonal shape with rounded corners; and/or
a portion designed for a positioning oriented toward an outside of a mouth with larger dimension than a portion designed for a positioning oriented toward an inside of a mouth.

4. The cicatrisation element as claimed in claim 1, wherein the terminal surface and/or the emergent surface has/have:
a nonplanar, curved surface; and/or
a convex surface; and/or
a surface with no roughness apart from the informative markers; and/or
a surface with no through opening.

5. The cicatrisation element as claimed in claim 1, wherein the characteristics identified by the informative markers comprise one or more of the following:
a height of the cicatrisation element,
a shape of the cicatrisation element,
dimensions of a connecting portion of the cicatrisation element to a post base, and indirectly of a dental implant,
an orientation of the dental implant, through an orientation of the cicatrisation element.

6. The cicatrisation element as claimed in claim 1, wherein the at least two informative markers comprise a first type of informative marking of a first characteristic of the cicatrisation element and a second type of informative marking of a second distinct characteristic of the cicatrisation element.

7. The cicatrisation element as claimed in claim 1, wherein each of the informative markers belongs to one of the following types:
a negative informative marker,
a positive informative marker,
an informative marker of specific and identifiable shape formed in one of the surfaces of the cicatrisation element,
an informative marker composed of a readable numerical value or of a readable identification code,
an RFID chip.

8. A series of cicatrisation elements, wherein the series comprises at least two cicatrisation elements as claimed in claim 1 having different shapes from each other.

9. The series of cicatrisation elements as claimed in claim 8, wherein the at least two cicatrisation elements have different heights from each other and/or have different cross sections of their lateral surfaces or different projections onto a parallel plane of their terminal surfaces.

10. A healing set capable of a connection to a dental implant during a cicatrisation phase of a dental restoration process, wherein the healing set comprises:
a cicatrisation element as claimed in claim 1, designed to be surrounded at least partially by a gum, and
a post base, designed to be fixed in an implant, the post base having a longitudinal axis for its entire length, able to be aligned with the axis of the implant.

11. The healing set as claimed in claim 10, wherein the post base has a symmetry or quasi-symmetry about the longitudinal axis of the post base.

12. The healing set as claimed in claim 10, wherein the cicatrisation element and the post base form two distinct elements and are assembled in a removable manner, and wherein
the post base comprises a connection device to an implant and a connection device to the cicatrisation element, the connection devices being situated about an axis aligned with and coinciding with the longitudinal axis of the post base, and
the cicatrisation element is situated about a central axis aligned with the longitudinal axis of the post base.

13. The healing set as claimed in claim 10, wherein the cicatrisation element comprises an anti-rotation element, configured to cooperate with an anti-rotation element of the post base, and to guarantee a fixation of the cicatrisation element in a unique orientation, without rotation about the post base.

14. The healing set as claimed in claim 10, wherein the at least two informative markers of the cicatrisation element comprise a first informative marking of a first characteristic of the post base and a second informative marking of a second characteristic of the post base.

15. A method of fabrication of a dental restoration post and/or of a denture, designed to be secured to a dental implant at a first end, wherein the method comprises:
producing a physical or digital impression of a buccal space, comprising a cicatrisation element as claimed in claim 1 secured to a dental implant;
automatically determining, and/or determining on the basis of data entered through a man/machine interface by an operator, a positioning of the dental implant and of the buccal space, on the basis of the impression and of the informative markers of the cicatrisation element.

16. The cicatrisation element as claimed in claim 5, wherein the characteristics identified by the informative markers comprise a shape and dimensions of a cross section of the lateral surface of the cicatrisation element or of a projection onto a parallel plane of the emergent surface.

17. The cicatrisation element as claimed in claim 7, wherein each of the informative markers belongs to one of the following types:
a negative informative marker recessed in one of the surfaces of the cicatrisation element,
a positive informative marker embossed on one of the surfaces of the cicatrisation element,
an informative marker having a polygonal shape or forming a polygonal line formed in one of the surfaces of the cicatrisation element,
an informative marker composed of a bar code or a data matrix code,
an RFID chip.

18. A series of cicatrisation elements, wherein the series comprises at least three cicatrisation elements as claimed in claim 1 having different shapes from one another.

19. The series of cicatrisation elements as claimed in claim 18, wherein the at least three cicatrisation elements have different heights from one another and/or have different cross sections of their lateral surfaces or different projections onto a parallel plane of their terminal surfaces.

20. The healing set as claimed in claim 12, wherein the cicatrisation element and the post base are assembled in a removable manner by clipping.
